(19) United States
(12) Patent Application Publication
(10) Pub. No.: US 2026/0290727 A1
(43) Pub. Date: Sep. 24, 2026

(54) NON-METAL SHIELDS AND USE OF FOAMY MATERIALS IN VACUUM INTERRUPTER, AND SWITCHGEAR EMPLOYING SAME

(71) Applicant: Wangpei Li, Pittsburgh, PA (US)

(72) Inventor: Wangpei Li, Pittsburgh, PA (US)

(21) Appl. No.: 19/083,594

(22) Filed: Mar. 19, 2025

(51) Int. Cl. H01H 33/662

(52) U.S. Cl. CPC H01H 33/66207; H01H 33/66261; H01H 2033/66223; H01H 2033/6623; H01H 2033/66269

(57) ABSTRACT

An arc-shield made of an insulating material surrounding the contact gap is provided to alleviate equipotential line congestion around metal parts and lessen electrical field concentration. Non-metal encapsulation of a metal shield for triple junction protection, and a non-metal plug to block line-of-sight of a triple junction, are devised to reduce exposed metal surfaces at a floating potential to minimize possible breakdown paths and limit metal vapor flashing onto the inside walls of the insulator members of the vacuum envelope. External triple junction protections are additionally applied, with a conformal coating and/or heat-shrink sleeve, to holistically address both internal and external dielectric performances. Foamy materials are employed to make existing or new parts inside arc chamber to boost capture of metal vapor and particles, to accelerate dielectric recovery of the vacuum interrupter in a warm condition during small load current switching or a hot condition during high fault current switching.

### BACKGROUND

### 1. Field

The disclosed concept relates to vacuum switching apparatus and, in particular, vacuum switching apparatus such as, for example, vacuum interrupters. The disclosed concept also relates to the triple junction protecting shields, and use of high surface area high open pore percentage components in a vacuum interrupter, and switchgear employing such a vacuum interrupter, such as gas-insulated switchgear, dead-tank vacuum circuit breakers, live-tank vacuum circuit breakers, generator circuit breakers, reclosers and fault interrupters.

### 2. Background Information

High voltage (HV) vacuum interruption has been the frontier of vacuum switching technology in the last 20 years (see e.g. U.S. Pat. No. 6,891,122, and E. Taylor “Environmentally friendly high-voltage switching technology: vacuum circuit breakers,” Chapter 3 in Green HV Switching Technology for Modern Power Networks, by K. Niayesh, IET 2023). There are, however, several challenges yet to overcome. Chief among them is the dielectric design to meet the high voltage requirements (see e.g. T. Heinz et al, “Why vacuum technology is not a simple scaling from medium to high voltage?”, 30^{th} ISDEIV, June 2023, Okinawa, Japan.) As an example for illustration, FIG. 1 shows a very typical HV vacuum interrupter rated for 66 kV or above, placed inside a surrounding tank. Internally inside the arc chamber of the vacuum interrupter, all the gaps between components of different electrical potentials have to pass the dielectric tests esp. the very demanding lighting impulse voltage test, without breakdown. If the tank is grounded, as in the case of a gas-insulated-switchgear (GIS) or a dead-tank (DT) circuit breaker, the dielectric stresses become much worse, as the zero-volt tank significantly depresses the potential of a nearby electrically floating metal component, such as the center shield 111 (commonly and herein referred to as the bellyband) in FIG. 1, leading to large asymmetry in the voltage distribution. Depending on how close the vacuum interrupter is to the tank (and there are tremendous motivations, both technical and financial, for the tank to be small!), the center shield will float to a potential as low as ⅓ of the full-test-voltage applied across an open contact gap. This means the voltage across the center shield to the high voltage end of the vacuum interrupter will be ⅔ of the full-test-voltage applied across the contact gap. Specifically, when the movable end is the high voltage end, the gaps G181 (a to c) must withstand that ⅔ of the full-test-voltage applied across the contact gap G195, and the gaps G183 and G185 must withstand about ⅓ of that full-test-voltage. Similarly, when the fixed end is the high voltage end (in another required test configuration), the gaps G187 (a and b) must withstand that ⅔ of the full-test-voltage applied across gap G195, and the gaps G189 and G191 must withstand about ⅓ of that full-test-voltage.

Because vacuum interruption technology is advancing against well-established existing switching technology using the green-house gas SF6, there is often a very tight limit on the size of a switchgear employing a vacuum interrupter, meaning the physical dimensions of the above-mentioned gaps are limited. One particularly challenging bottleneck is around the end-curl 141 (m and f, but we will only discuss about 141m herein for the economy of disclosure). To shield the triple junction of the joint between bellyband 111 and ceramic 105m, end-curl 141m has to go around the corner of that joint and inside the ID (inside diameter) wall of 105m. It also has to curl inward toward the movable electrode enough to provide an adequate vapor catching function to protect the ID wall of 105m against dielectric degradation from deposition of metal vapor coming from gap G195. This leads to the formation of a very narrow passageway for the electrical equipotential lines to flow through. As a result, high electrical concentration occurs at the narrowest points such as the tip of end-curl 141m, the corner of bellow shield 123, and the bottom of coil 125. To ensure that gap G181 will withstand reliably the very demanding ⅔ of full-test-voltage, extensive conditioning treatment has to be carried out on the surfaces around these high electrical field locations. (See e.g. P. Slade, “The Vacuum Interrupter, Theory, Design, and Application,” 2nd Ed., CRC Press, 2021, section 1.3.7, p86.) The problem is, a conditioning process works via repeated flashovers, but a high number of these flashovers on the stainless-steel parts of 141m and 123 flashes a layer of their metal vapor onto the nearby ID wall of ceramic 105m. So the protector, end-curl 141m, itself becomes a cause of the problem it is designed to protect against.

Similarly, the floating shields 143m and 143f are there to protect the triple junctions associated with the joints between insulators 103 (m and f) and 105 (m and f). Being at a floating potential different from those of the movable end and the fixed end, flashover can happen to them. When a momentary flashover happens, for example, between movable end 137 and floating shield 143m, both become having the same potential. This means that the above mentioned ⅔ of full-test-voltage now appears across gap G185 between 143m and 141m, which is beyond its normal withstand capability. So breakdown will develop across gap G185, and further evolve into a full flashover between movable end 137 and fixed end 139. In other words, floating shields 143m and 143f are potential steppingstones for a full breakdown; their presence inside the arc chamber increases the number of potential breakdown paths via which a dielectric failure can happen. As a precaution so that to ensure the successful passing of all the stringent dielectric tests required of a HV vacuum interrupter, the surfaces of shields 143m and 143f ought to be conditioned. But this brings in the above-mentioned dilemma of repeated conditioning shots on them leading to flashing of their metal vapor onto the nearby ceramic surfaces.

Another challenge yet to be overcome in developing a HV vacuum interrupter has to do with the dielectric strength of a warm vacuum gap, while switching a small current. Metal particles are generated during such a small current interruption. These particles can lead to late breakdowns, esp. during a capacitive switching test. (See e.g. R. Smeets, Switching in Electrical Transmission and Distribution Systems, Wiley Pub., 2015, section 4.2.4, p104.) Various attempts to address this challenge have been made, including one recent German Patent Application, DE102022207491A1.

There is, therefore, room for improvement in the design of a HV vacuum interrupter.

### SUMMARY

The novelty of the disclosed concept is to incorporate new non-metal materials into the construction of the arc chamber of a vacuum interrupter.

As an aspect of the disclosed concept, a non-metal material is provided for the arc-shield surrounding and directly facing the contact gap. Unlike a metal, an insulator/insulating material (that is not a layer on a metal substrate or backing) allows the equipotential lines of voltage to go through it. By using an insulator material as the arc-shield, the problem associated with congestion of electrical equipotential lines and resulting field concentration at the narrowest points of the passageway of the equipotential lines, can be alleviated, thus enabling a drastically improved internal dielectric performance of the vacuum interrupter.

As another aspect of the disclosed concept, a non-metal material is provided for any or all of the ceramic protection shields inside the arc chamber of a vacuum interrupter. Minimizing the presence of exposed metal surfaces at a floating electrical potential inside the arc chamber reduces the possible paths via which a breakdown can take place, hence the statistical probability of flashover, and also limits the metal vapor generated by a flashover that can coat and degrade the nearby surfaces of the insulator members of the vacuum envelope, thereby not only improving the dielectric performance but also extending the electrical life of the vacuum interrupter.

As yet another aspect of the disclosed concept, a high surface area high open pore percentage foamy material is introduced into the arc chamber, either for existing part or parts, or as a new component, to improve vapor and particle capture, thereby accelerating the dielectric recovery of the vacuum gaps after current zero, under either a warm condition, such as while interrupting a small load current, or a hot condition, such as while interrupting a high fault current.

As yet another aspect of the disclosed concept, vacuum switching apparatus, such as gas-insulated switchgear, dead-tank vacuum circuit breakers, live-tank vacuum circuit breakers, generator circuit breakers, reclosers and fault interrupters, employing one such vacuum interrupter comprising one or multiple of the disclosed non-metal and/or foamy components, is also provided.

### BRIEF DESCIPTION OF THE DRAWINGS

A full understanding of the disclosed concept can be gained from the following description of the preferred embodiments when read in conjunction with the accompanying drawings in which:

FIG. 1 is a sectional view of a vacuum interrupter in accordance with the prior art, wherein the portion to the left of the vertical axis shows the closed position and the portion to the right of the vertical axis shows the open position;

FIG. 2 is a sectional view of a vacuum interrupter of an embodiment in accordance with the disclosed concept, employing an arc-shield made of an insulator material;

FIG. 3A is a 2-D electrical simulation plot of equipotential lines for the vacuum interrupter in FIG. 1, with the high voltage applied to the movable end, and the tank grounded;

FIG. 3B is a 2-D electrical simulation plot of equipotential lines for the vacuum interrupter in FIG. 2, with the high voltage applied to the movable end, and the tank grounded;

FIG. 4 is a half isometric half sectional view of a vacuum interrupter, of another embodiment in accordance with the disclosed concept, having a middle ceramic cylinder outside the non-metal arc-shield, and incorporating several of disclosed features;

FIG. 4A is an enlarged sectional view of a metal shield for triple junction protection being encapsulated in a glass cover;

FIG. 4B is an enlarged sectional view of a triple junction plug that blocks the line-of-sight of the metal members of the triple junction to all other metal members away from the triple junction;

FIG. 5 is a sectional view of a vacuum interrupter of another embodiment in accordance with the disclosed concept, having a non-metal arc-shield with wavy contour, and a short metal bellyband surrounding the non-metal arc-shield;

FIG. 6 is a sectional view of a vacuum interrupter of another embodiment in accordance with the disclosed concept, employing only two tall ceramics for the vacuum envelope;

FIG. 7 is a sectional view of a vacuum interrupter of another embodiment in accordance with the disclosed concept, employing two end-curls made of a non-metal material, each being retained by a step on the metal bellyband;

FIG. 8 is a sectional view of a vacuum interrupter of another embodiment in accordance with the disclosed concept, employing two end-curls made of a glass, each being permanently joined to the metal bellyband via a Kovar metal insert;

FIG. 9 is a sectional view of a medium voltage vacuum interrupter of another embodiment in accordance with the disclosed concept, employing a non-metal arc-shield, a pair of contact shields made of a foamy material, and a new vapor catcher part around the fixed electrode; and

FIG. 10 is a sectional view of a medium or low voltage vacuum interrupter of another embodiment in accordance with the disclosed concept, employing a fixed shield made of a large body of a foamy material.

All sectional views herein are taken across a diameter and along the longitudinal central axis of the generally tubular vacuum interrupter.

### DESCIPTION OF THE PREFERRED EMBODIMENTS

As employed herein, the singular forms “a,” “an,” and “the” include plural references unless the context clearly dictates otherwise. Unless defined otherwise, all technical and scientific terms used in this document have the same meanings as commonly understood by one of ordinary skill in the art. As employed in this document, the term “comprising” (or “comprises”) means “including (or includes), but not limited to.”

As employed herein, terms such as “top” and “bottom,” “upper” and “lower,” “left” and “right,” or “front” and “back,” are not intended to have absolute orientations but are instead intended to describe relative positions of various components with respect to each other.

As employed herein, the term “vacuum envelope” means an envelope employing a partial vacuum therein. As employed herein, the term “partial vacuum” means a space (e.g. within a vacuum envelope) partially exhausted (e.g. to the highest degree practicable; to a relatively high degree; to a degree suitable for use in a vacuum switching apparatus application) by a suitable mechanism (e.g. without limitation, a vacuum furnace).

The disclosed concept is described in association with vacuum interrupters, although the disclosed concept is applicable to a wide range of vacuum switching apparatus. Non-limiting applications for vacuum switching apparatus include a live-tank (LT) circuit breaker, a dead-tank (DT) circuit breaker, a gas insulated switchgear (GIS), a compact/cubicle gas insulated switchgear (C-GIS), a generator circuit breaker, a vacuum circuit breaker (VCB), a recloser, a fault interrupter, a load break switch (LBS), a high voltage (HV) switching apparatus, and a vacuum electrical switching apparatus, for an alternate current (AC) or a direct current (DC) power system.

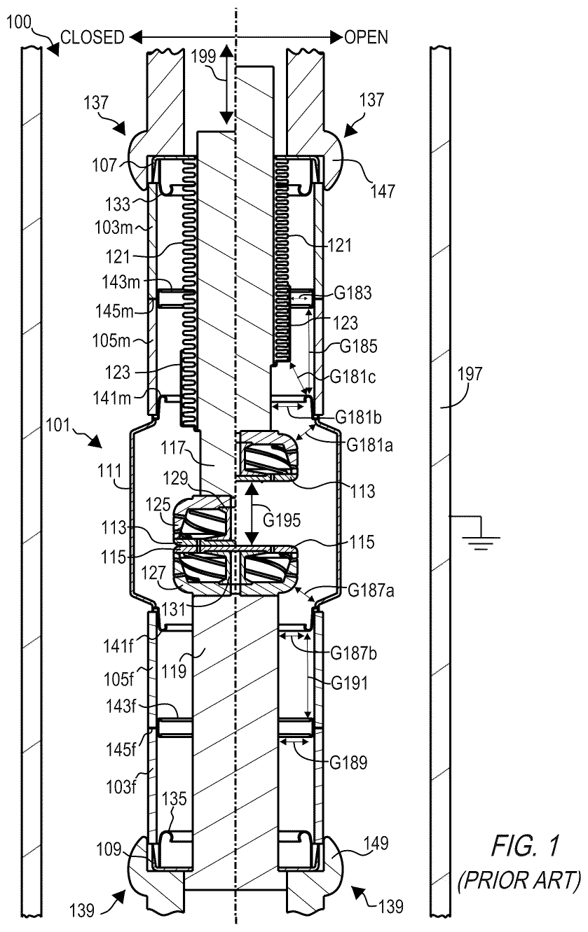

As mentioned in the beginning, FIG. 1 shows a typical HV vacuum interrupter 100 in accordance with the prior art. It includes a vacuum envelope 101 comprising four generally tubular insulator members 103m, 103f, 105m and 105f caped with two metal end-caps 107 and 109. Also part of the vacuum envelope is an electrically floating center shield 111, commonly and herein referred to as the bellyband, that surrounds a pair of separable contacts, the movable contact 113 and the fixed contact 115. The bellyband serves to collect metal vapor and spatters generated in the arcing contact gap in between contacts 113 and 115. Two electrodes 117 and 119 connect the contacts to the busbars (not shown) of the external electrical power line a switchgear employing the vacuum interrupter is protecting. The movable electrode 117 also connects the movable contact 113 to an external driving mechanism (not shown) to move it in the direction of the arrow 199 between a closed position (left side of the vertical axis of FIG. 1) in electrical contact with the fixed contact 115, and an open position (right side of the vertical axis of FIG. 1) spaced apart from the fixed contact 115. A bellows 121 facilitates the transfer of this motion from the exterior to the interior of vacuum envelope 101. A bellows-shield 123 protects the thin-walled bellows from any molten spatter originating from arcing activities in between the opening contacts. The exemplary vacuum interrupter shown in FIG. 1 is the axial magnetic field (AMF) type, employing two AMF generating coils 125 and 127 in between the contact and the electrode for the movable end and the fixed end respectively. Two pillar pieces 129 and 131 inside the coils provide mechanical support to the bottom (non-arcing) side of the thin contacts. Often there are also the end-shields 133 and 135 that protect the triple junctions of the metal-to-insulator joints (see more later). Commonly in the field the metal parts are grouped into two ends, the movable end 137 and the fixed end 139, separated by the insulator members 103m, 103f, 105m, and 105f. Movable end 137 (the upper or top end in FIG. 1) includes the electrically connected parts 107, 113, 117, 121, 123, 125, 129, and 133, all holding one first electrical voltage/potential. Fixed end 139 (the lower or bottom end in FIG. 1) includes the electrically connected parts 109, 115, 119, 127, 131, and 135, all holding a same second electrical voltage/potential, when the vacuum interrupter is in the open position.

The generally tubular insulator members 103m, 103f, 105m, and 105f of the vacuum envelope define a common longitudinal axis, the vertical axis of FIG. 1, for vacuum interrupter 100.

A critical concept to both vacuum dielectric and gas dielectric is the triple junction, of the metal-insulator-vacuum junction on the interior of the vacuum envelope, or the metal-insulator-gas junction on the exterior of the vacuum envelope. It is commonly understood that a triple junction is the main source of the starting electrons that eventually lead to a flashover across an insulator, in vacuum or in a gas. For that reason, two end-curls 141m and 141f, each going around the corner of the joint and inside the ID wall of insulator 105m and 105f, respectively, are provided to protect the internal triple junctions associated with bellyband 111.

The exemplary envelope design as shown in FIG. 1 uses two stacked-together insulator members (103 and 105) on each side of bellyband 111. If these insulator members are of a glass material, they are joined hermetically sealingly via a Kovar metal piece (or pieces). If these insulator members are of a ceramic material such as alumina, they are hermetically sealingly joined together via a metallization layer (of Mo-Mn topped with Ni) at the ends of their generally tubular shape. Either way metal is involved in the joining, so associated triple junctions need to be protected. This is the reason for the presence of the floating shields 143m and 143f in FIG. 1, to protect the vacuum side triple junctions. These floating shields are secured to the insulators via a flange, 145m and 145f respectively, that is sandwiched in between, and hermetically searlingly joined with, the insulators.

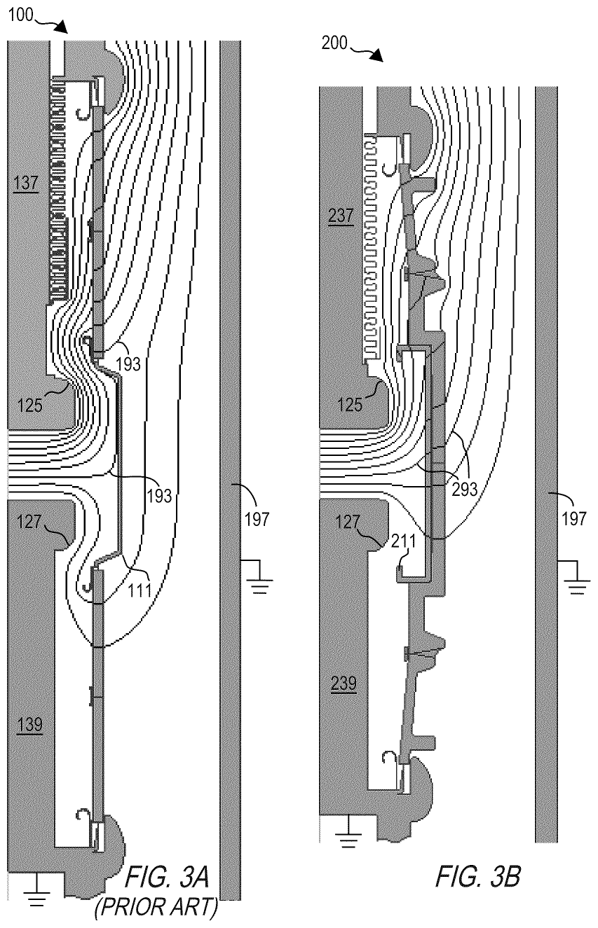

There are two more triple junctions for the vacuum interrupter in FIG. 1: the insulator joints to the two end-caps 107 and 109. Internally in the vacuum side, end-shields 133 and 135 serve that protection purpose. Externally, the protection is provided by the (proper design of the generally wedge-shape portion of the) conductors, 147 and 149 respectively, that connect the vacuum interrupter to the external busbars (not shown). (In the switchgear industry conductors are not considered parts of the vacuum interrupter. They are shown herein as they affect the electrical equipotential plots of FIG. 3A and FIG. 3B. Note that conductor 147 is at the same potential as the movable end 137, and conductor 149 is at the same potential as the fixed end 139.)

When used in a high voltage switchgear, the vacuum interrupter is typically placed inside a container of a dielectric medium surrounding the vacuum interrupter. If this container, commonly and herein referred to as the “tank”, has an insulator portion electrically separating its two metal ends, a circuit breaker of such construction is called a “live-tank” (LT) circuit breaker. If the tank is an all-metal container, and for safety consideration an electrically grounded one, such as 197 shown in FIG. 1, such a switchgear can be a “dead-tank” (DT) circuit breaker, or a gas-insulated-switchgear (GIS). (While FIG. 1 shows one vacuum interrupter within tank 197, there can be more than one vacuum interrupter within a tank. For rated voltages at and below 170 kV, it is typical to have three phases, meaning three vacuum interrupters for a vacuum switching GIS, in a common tank. The three vacuum interrupters can be arranged linearly, or in a triangular pattern.)

With a zero-volt tank close by, the floating bellyband 111 (and end-curls 141m, 141f) will pick up a voltage that is significantly lower than half, as low as ⅓ (depending on how close the tank is), of the full-test-voltage applied across a contact gap G195 in between the movable end 137 and the fixed end 139. If we arbitrarily pick the movable end as the high voltage end in a dielectric testing setup, gaps G181 (a to c) must withstand that ⅔ of the full-test-voltage applied across gap G195, and gaps G183 and G185 must withstand about ⅓ of that full-test-voltage. (As employed herein, a contact gap is the physical space between the pair of separable contacts in a vacuum interrupter when the vacuum interrupter is in its fully open position at its specified contact gap or contact stroke, along the longitudinal central axis of the vacuum interrupter. In FIG. 1, gap G195 is the contact gap.)

Referring to FIG. 3A now, it shows a 2-D plot, obtained via electrostatic simulation software ANSYS Electronics Desktop, of voltage distribution in a dead-tank circuit breaker with vacuum interrupter 100 inside and in its open position. The 100% full-test-voltage is applied to the movable end 137, with both the fixed end 139 and the tank 197 being grounded, i.e. at zero volt. There are nine equipotential lines, each representing an increase of 10% of the full-test-voltage from its preceding line, starting from the zero-volt fixed end 139. With the tank at zero volt and bellyband 111 being a metal, which behaves like an impenetrable wall to the equipotential lines, only two equipotential lines flow around the fixed end-curl 141f, downward first then up, in FIG. 3A; the other seven of them flow up and through the narrow passageway in between end-curl 141m and the coil 125, the movable electrode 127, and the bellows-shield 123. Pay particular attention to the 3^{rd} equipotential line, labeled 193. It traces around the tip of end-curl 141m, going upward then downward then upward again, in FIG. 3A. This is an indication of a high electrical field concentration around the tip of end-curl 141m.

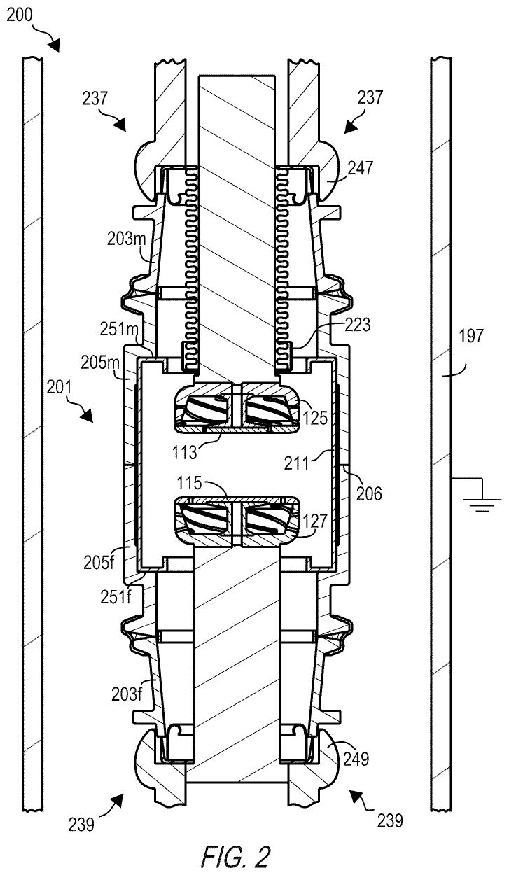

As a comparison, FIG. 2 shows a vacuum interrupter 200 in accordance with the disclosed concept. In place of the all-metal arc-shield assembly of 111+141m+141f for vacuum interrupter 100, vacuum interrupter 200 employs a single piece arc-shield 211 that is made of an insulator material, which is penetrable to the equipotential lines (when there is no metal substrate or backing behind it). FIG. 3B shows the 2-D simulation plot of voltage distribution for vacuum interrupter 200 inside the same tank as in FIG. 3A. All simulation parameters are also identical to those used for FIG. 3A. Just like in FIG. 3A, only two equipotential lines flow below the center metal joint 206 outside the contact gap. However, five of the seven other lines, including the 3^{rd} line labelled 293, now flow through, rather than around, arc-shield 211, leaving only two equipotential lines to flow through the gap in between arc-shield 211 and bellows-shield 223. It can be seen that arc-shield 211 being an insulator instead of a metal drastically alleviates the congestion for the flow of the equipotential lines. As a result, electrical field concentration at the usual problematic points along the narrow passageway of the equipotential lines, such as the bellows-shield corner and the back of the coil, has been greatly lessened, leading to much improved dielectric withstand capability of the arc chamber, and complete avoidance or at least a large reduction of the need for extensive conditioning treatment around those locations. Moreover, there is no more of the metal surface of end-curl 141m that can flash metal vapor onto the ID wall of ceramic 105m, when there is an internal breakdown to it, unintentional or intentional (as in a conditioning treatment).

Since an arc-shield such as 211 is directly exposed to the arc that is drawn in between the opening contacts, it needs to be made of a material that has a good arc resistance and thermal shock resistance, in addition to other properties such as low outgassing and low thermionic electron emission. Potential candidate materials include but are not limited to: boron nitride, cordierite, zirconia, silicon carbide, silicon nitride, magnesium aluminate, alumina, and mullite.

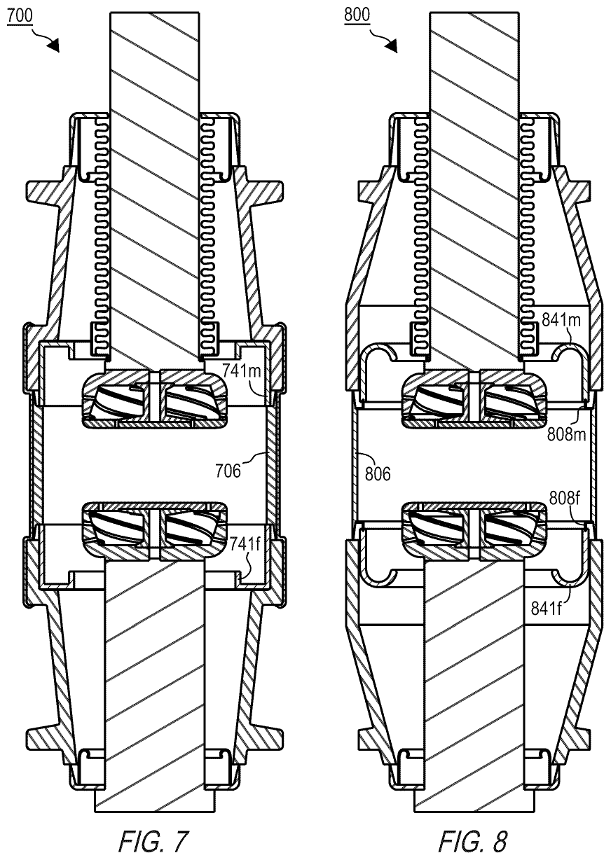

One very important point to note is that insulator arc-shield 211 is secured to the vacuum envelope 201 via two steps, 251m and 251f, formed on insulators 205m and 205f respectively. If it were to be secured via any metal component, just like end-curls 741m in FIGS. 7 and 841m in FIG. 8, new triple junctions would have been formed that would require new shielding.

Nowadays most insulators used for the vacuum envelope of a vacuum interrupter are of the metallized alumina type, made from a cold-isostatically-pressed cylinder that is machined into its final shape. To form a step such as 251m in insulator 205m, or to enable the frustoconical shape of insulator 203m, a thick wall starting cylinder is needed. Because of practical limit on thickness and height of commercially available alumina parts, it is probably unavoidable that multiple alumina pieces be used in the construction of a vacuum envelope for a high rating such as 245 kV and 63 kA or above. Alumina is joined to other members of the vacuum envelope via metallization. As a result, each end of an alumina ceramic insulator forms a triple junction that requires protection, typically by employing a shield such as 143m or 143f.

As employed herein, a metal shield for triple junction protection is a metal part that is placed in close proximity to a triple junction of a metal-insulator-vacuum joint or a metal-insulator-gas joint, and having certain geometrical profile to deflect the electrical equipotential lines around the triple junction, to alleviate the electrical field concentration effect associated with such triple junction.

As explained earlier, metal shields for triple junction protection such as 143m and 143f are potential risks of becoming steppingstones that facilitate an internal flashover; their presence increases the likelihood of breakdown in a dielectric test; and each flashover on their surfaces flashes some metal vapor and/or even particles onto the nearby surfaces of the insulator members of the vacuum envelope, leading to gradual degradation of its dielectric capability.

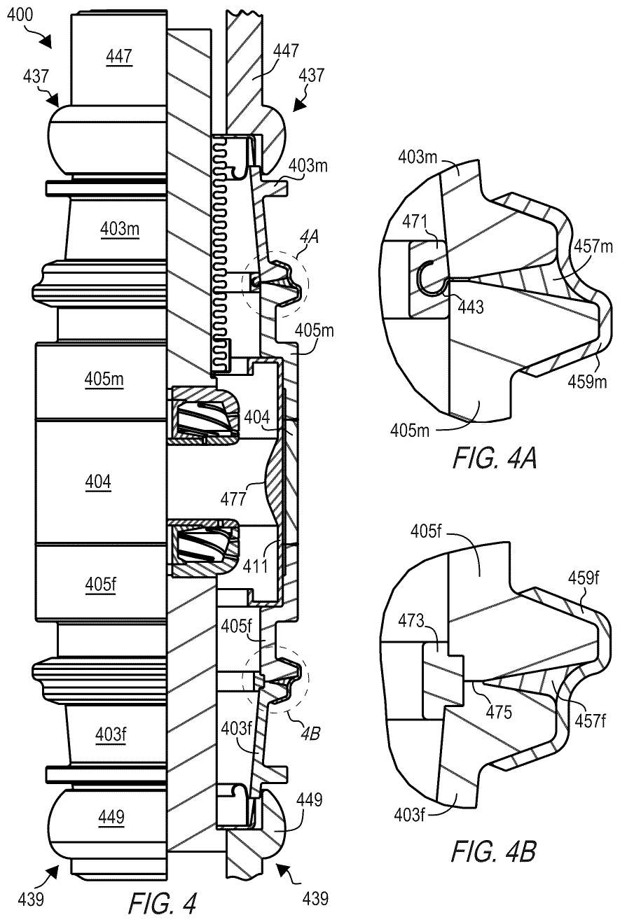

Referring to FIG. 4 now, it shows a vacuum interrupter 400 in accordance with the disclosed concept, to address the above-mentioned problems associated with a metal shield for triple junction protection. (The busbar connecting conductors 447 and 449, not parts of the vacuum interrupter, are also shown in the drawing.) As can be seen in the enlarged view of FIG. 4A, the exposed portion of the triple junction protection metal shield 443 is encapsulated in an insulator such as a glass, 471. By doing so the high electric field portion of 443 is obstructed from contributing to a breakdown, and even if a breakdown happens to it (for example during a conditioning treatment process), the amount of metal vapor generated will be very limited. It is relatively easy to wrap a molten glass ring around a metal insert, or to embed a metal insert in a green body of a ceramic insulator, as long as the thermal expansion mismatch concern is being addressed, by selecting a compatible metal, such as Kovar, for the metal shield 443. The joint in between 443 and 471 does not need to be hermetical but rather only mechanical, in this application.

Another solution to minimize the presence of an exposed metal part of a floating potential inside the arc chamber is provided in FIG. 4B. An insulator ring, a “triple junction plug” 473, is employed, in conjunction with the corresponding recesses formed in insulators 405f and 403f, to block the line-of-sight of the triple junction, labelled 475, associated with the joint between 405f and 403f, to all other metal components away from the triple junction. By doing so, that triple junction (formed by the metallization layers on both 405f and 403f) is obstructed from becoming a steppingstone to facilitate a breakdown, and even if a breakdown happens to it, the amount of metal vapor generated will be very limited.

The geometry of a triple junction plug does not have to be the exact shape as that of 473 shown. It can be a wedge or a clamp or a cover of some sort. As employed herein, a triple junction plug is a non-metal part for a vacuum interrupter that, in conjunction with corresponding geometrical feature or features designed into the insulator member or members forming the triple junction, blocks the line-of-sight of the metal member or members of a triple junction to other metal components of the arc chamber inside the vacuum interrupter and away from the triple junction.

Also, the material for such a triple junction plug does not have to be an insulator, although an insulator material with a thermal expansion coefficient closely matching that of insulators 403f and 405f will offer a tight fit between the plug and insulators 403f and 405f. It is possible for the plug to be made of a semiconductor material, such as zinc oxide or silicon carbide, for an optimum modulation of the dielectric permittivity of the members forming the multiple junction.

It is important for such a plug, esp. one made of an insulator material, to be secured in position without relying on a metal retainer means, so that no new triple junction is created at the interface between the plug and the metal retainer means. (Triple junction electrical field concentration is not as significant a concern for a metal insert embedded into a molten glass.)

In FIGS. 4A and 4B it is exemplarily shown that externally, the triple junctions are sealed with an insulating sealant 457m or 457f, such as a conformal coating, and an insulating cover 459m or 459f, such as a heat-shrink sleeve (not drawn to scale) or an electrical tape, or even a silicone or polyurethane potting. For an ecofriendly high voltage switchgear employing a SF6-alternative gas as the insulating medium inside the tank, the external dielectric stress across the insulators of the vacuum envelope is very high. Protection of a triple junction will not be successful unless both internal and external dielectric performances are addressed together.

FIG. 4 also shows a feature in accordance with another aspect of the disclosed concept: the use of a high surface area material, for the arc-shield 411. As mentioned in the beginning of this disclosure, another challenge yet to be overcome in high voltage vacuum interruption technology is the capacitive switching performance. It is believed that late breakdowns causing failure in a capacitive switching test are likely triggered by particles that are generated while the contacts are switching a small load current. These particles of a wide spectrum of sizes bounce between the anodes and the cathodes inside the arc chamber during the dielectric recovery stage of the interruption process, and in the wrong place and at the wrong time, can initiate a breakdown under the high recovery voltage associated with a capacitive switching circuit.

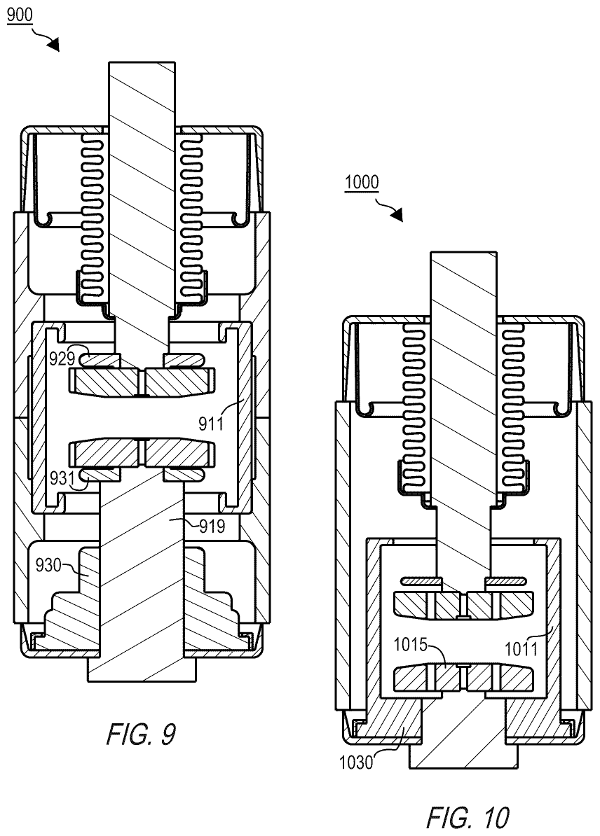

To address this problem, arc-shield 411 can be made of an arc-resistant material with a high specific surface area and high percentage of open pores. The high surface area increases its ability to capture metal vapor, and the open pores increase its ability to capture particles. To also have the previously mentioned function of alleviating electrical field concentration and improving dielectric performance, a high surface area arc-shield made of an insulator material is preferred. (Potential candidate materials include but are not limited to: a cordierite foam, a calcium aluminate foam, a silicon nitride foam, an alumina foam, a boron nitride foam, or a zirconia foam.) But if it is necessary to sacrifice a little bit of the dielectric performance, or if the dielectric improvement function of an insulator arc-shield is not necessary, such as for a medium voltage (MV) or low voltage (LV) vacuum interrupter, a high specific surface area arc-shield made of a metal foam, such as a copper foam or a steel or iron foam, or a high specific surface area arc-shield made of an inorganic conductor or semiconductor foam such as a carbon foam or a silicon carbide foam, can also be considered, as will be exemplified by part 911 in FIG. 9 and part 1011 in FIG. 10. (Note such a porous shield is not to be confused with a mini-device called getter, of sintered porous metals, that is almost universally present in every commercial vacuum interrupter, for absorbing/adsorbing active gases to help maintain the expected 30-year life of the hermetically sealed vacuum chamber.)

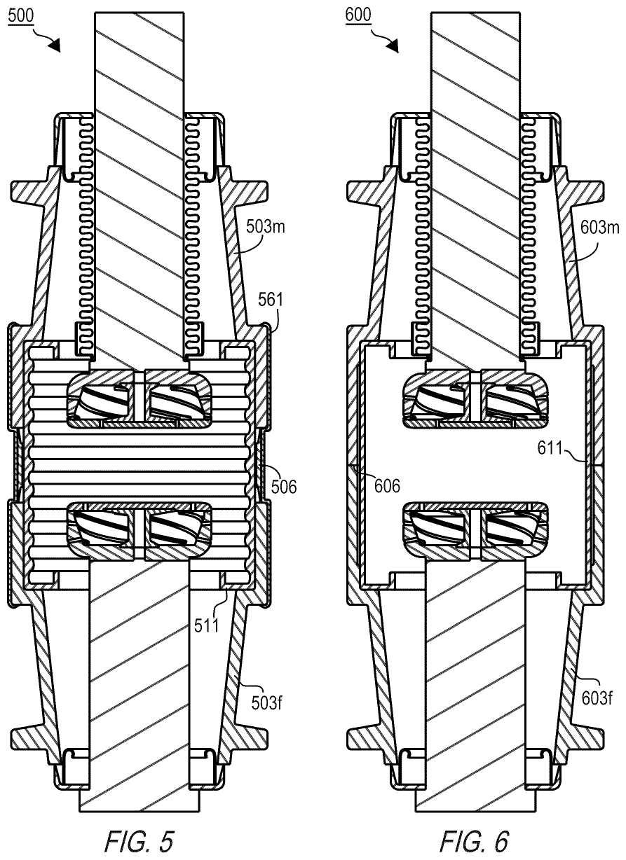

To further improve this function of capturing metal vapor and particles coming from the contact gap, the geometry of such an arc-shield of a high surface area material can be of a more complex shape than a simple straight wall with a uniform ID like that of 211 in FIG. 2. The example of 411 as shown in FIG. 4 has a protrusion into the contact gap, 477, for this purpose. The optimum shape of such a protrusion, or of other geometrical features, such as a wavy cross-sectional contour as shown in arc-shield 511 for vacuum interrupter 500 in FIG. 5, to improve the ability to capture metal vapor and particles, can be further researched and developed.

Just like arc-shield 211 in FIG. 2, arc-shield 411 is secured in position via two steps formed on the ceramic 405m and 405f respectively, rather than via any metallic retaining means. This is a very important characteristic of this disclosure. It is not only because of the need to avoid forming a new triple junction at the interface between the insulating arc-shield and its metallic retaining means, but in this case also because a foamy arc-shield will not be easy to braze: the pores will suck up the molten braze filler, robbing it from the intended joint area, to cause a braze joint failure.

As a non-limiting example, vacuum interrupter 400 is shown to use one middle ceramic 404, to facilitate the construction of the vacuum envelope, out of commercially available thick-wall metallized alumina ceramics, for a high rated voltage such as 170 kV or above. More than one such middle ceramic can be used.

As can be seen in the 2-D simulation in FIG. 3B, only three of the nine equipotential lines flow through the portion corresponding to the contact gap, of arc-shield 211. That means the electrical fields around that portion of the arc-shield are not very high. So if necessary, for cost and/or manufacturability reasons, part of the vacuum envelope can consist of a metal bellyband, such as 506 in FIG. 5. Doing so may make it more commercially practicable to use only one insulator member, 503m, instead of the two of 403m and 405m in FIG. 4, on each side of the contact gap, to provide enough external dielectric need for the vacuum envelope. A benefit of doing so is the avoidance of the triple junction of the joint between two insulator cylinders. A disadvantage is that, as compared to the case with arc-shield 211 or 411, in this case the equipotential lines will have to flow around, not through, this metal bellyband 506. As a result, the effect of alleviation of electrical field concentration as provided by 511 is not as strong as that provided by 211 or 411. Also, two new triple junctions now exist, at the two ends of the bellyband 506. Even though they are hidden behind arc-shield 511, they are still potential weak points dielectrically.

To minimize the likelihood of the metallic bellyband 506 becoming a steppingstone of external flashover, it is covered with a heat-shrink sleeve 561 (not drawn to scale) or even a silicone or polyurethane potting. An external flashover from the movable end 137 to bellyband 506 can lead to a subsequent internal breakdown between bellyband 506 and the fixed end 139. See e.g. W. Li et al, “Measuring external dielectric strength of the vacuum interrupter envelope,” 28^{th} ISDEIV, Greifswald, Germany, Sept. 2018. In other words, the internal dielectric and the external dielectric performances are interconnected, therefore must be addressed holistically.

For a relatively low rated voltage such as 145 kV or below, it may be commercially feasible to use just one single tall insulator member on each side of the contact gap without an exposed metal bellyband, as shown for vacuum interrupter 600 in FIG. 6, which is another embodiment of the disclosed concept. In such a simple and neat construction, the only metal parts of the arc chamber that are at a floating potential are the thin metallization layers, labelled together as item 606, at the joint between insulator 603m and 603f. With them well hidden behind a tall insulator shield 611, it may very likely be achievable for any internal breakdown in such a vacuum interrupter to be limited to only between the contacts (possibly via the arc-shield 611 once it starts to collect some metal vapor and particles). Such a vacuum interrupter will have an outstanding dielectric capability, as there are simply not many potential paths for a breakdown to take place.

If necessary, for example out of cost saving or manufacturability considerations, the single tall insulator arc-shield of 611 can be substituted with two short pieces of 741m and 741f, as shown for vacuum interrupter 700 in FIG. 7, which is another embodiment in accordance with the disclosed concept. With such construction, 741 (m or f) does not have to be made of an arc-resisting material. It can be a low cost ceramic piece that rests on a step machined on a thick-wall metallic bellyband 706 as shown in FIG. 7, or it can be a glass 841 (m or f) that is permanently secured to the envelope via a Kovar insert 808 (m or f) that is brazed or welded to bellyband 806, as shown for vacuum interrupter 800 in FIG. 8. A disadvantage with such a construction is that new triple junctions are formed between these insulator parts and their metallic retaining means.

The teaching to introduce non-metal components into the construction of the arc chamber of a vacuum interrupter is very much applicable to not only a high voltage vacuum interrupter but also to a medium voltage or a low voltage vacuum interrupter. Vacuum interrupters are increasingly being used for extended duration of time in the open state while sustaining a voltage, especially in the medium or low voltage ranges. In such a situation it is of paramount importance for any momentary breakdown inside the arc chamber to be limited to only between the open contacts; the other components of the arc chamber, especially the stainless-steel components, are not designed to endure a significant number of repeated flashovers. Making the arc-shield out of a non-metal material can greatly reduce the likelihood of flashover between the arc-shield and the bellows-shield, and minimize the flashing of metal vapor onto nearby insulator surfaces when there is a flashover between them or around them. As non-limiting examples, vacuum interrupters 900 in FIGS. 9 and 1000 in FIG. 10, both being embodiments of the disclosed concept, are shown to employ one such non-metal arc-shield, 911 and 1011 respectively.

Note that both vacuum interrupters 900 and 1000 are of the transverse magnetic field (TMF) type, each employing a pair of spiral contacts to control the arc for high fault current interruption. This type of vacuum interrupters is particularly suitable for the application of a high surface area material component, in accordance with the disclosed concept. The slots machined on the spiral contacts generate a transverse magnetic field that forces the constricted arc column of a high current to spin around the edge of the contact, to spread out the thermal load over a large area of the contact. In doing so a lot of metal vapor and molten metal droplets of the contact are splashed outwardly toward the arc-shield and through the slots toward the back (non-arcing) side of the contact. Employing one or more components made of a high surface area material such as a carbon foam or a silicon carbide foam in the arc chamber construction will facilitate a fast capture and condensation of the splashes, thereby accelerating the dielectric recovery of the contact gap immediately after current zero, to result in an improved high current interruption performance.

As non-limiting examples, the arc-shield 911 and the contact shields 929 and 931 in FIG. 9 can be made of a high surface area high open pore percentage material or materials. (The dielectric benefit from using an insulator arc-shield in alleviating field concentration, as described earlier, is not as necessary for a MV or LV vacuum interrupter as for a HV vacuum interrupter, so a conductive/conductor material such as graphite, or a semiconductive/semiconductor material such as silicon carbide, or a metal such as copper or steel, can be the candidate material for the foamy shield 911, 929, or 931. For arc-shield 911 such a foamy material shall preferably be arc-resistant.) Additionally, a new part, a “vapor catcher” 930, also made of a high surface area high open pore percentage material, is placed around the fixed electrode 919, to further boost the capture of metal vapor and droplets. Being further away from the contact gap, part 930 sees mostly metal vapor and not so much droplets that escape from the contact gap. So it can very well be made of a metal foam such as a stainless-steel foam or a copper foam, for potentially better metal vapor catching. It can certainly also be made of a conductor foam such as carbon foam or a semiconductor foam such as silicon carbide foam or an insulator foam such as alumina foam. For vacuum interrupter 1000, the arc-shield 1011, made of a high surface area high open pore percentage material such as a carbon foam or a silicon carbide foam or an alumina foam or a copper foam, has a thick bottom portion (1030) behind (underneath) the fixed contact 1015, to serve this purpose of boosting the capture of metal vapor, to improve the high current interruption capability of the vacuum interrupter.

Note that since a high surface area part does not lend itself well to brazing (---as described earlier, the pores will suck up all the molten braze filler, robbing it from the intended joint area), all the foamy components in FIGS. 9 and 10 are secured in position via mechanical retaining means rather than permanent joining.

For the ease of illustration and economy of disclosure, only vacuum interrupters of the AMF and the TMF types are shown in the examples of FIGS. 1-10. However, it will be understood that the disclosed concept can be used in any known or suitable combination or alternative arrangement with any known or suitable alternative vacuum switching apparatus therefor, without departing from the scope of the disclosed concept. For example and without limitation, it can be used in a vacuum interrupter with a pair of butt contacts, or a vacuum interrupter of a hybrid of the TMF and AMF interrupting principles, or a vacuum switching apparatus having two movable ends rather than the aforementioned arrangement of a movable end and a fixed end, or a vacuum switching apparatus having more than two contacts such as a 3-position vacuum switch. It can also be used for vacuum earthing switches, vacuum spark-gaps, vacuum fuses, and other vacuum switching devices. As technology advances in both vacuum interruption and material manufacturing, new ways to apply a vacuum interrupter may evolve, as well as new foamy materials. Various modifications and alternatives to the specific embodiments could be developed in light of the overall teachings of the disclosed concept which is to be given the full breadth of the claims appended and any and all equivalents thereof.

1. A non-metal shield of a high voltage vacuum interrupter for a high voltage switching apparatus rated for 66 kV or above, said switching apparatus comprising said vacuum interrupter and a tank enclosing a dielectric medium surrounding said vacuum interrupter, said vacuum interrupter comprising a vacuum envelope and both said non-metal shield and a pair of separable electrical contacts inside said vacuum envelope,
wherein said generally tubular vacuum interrupter has a longitudinal central axis,
wherein said pair of separable contacts defines a contact gap, of the physical space between them along said axis, when said vacuum interrupter is in its fully open position according to its specified contact gap or contact stroke, and
wherein said non-metal shield is an arc-shield surrounding said contact gap, and is the innermost component radially from said axis, in a cross-section taken along a plane perpendicular to said axis, in the portion corresponding to said contact gap along said axis, of said vacuum interrupter in its fully open position.

2. The non-metal shield of claim 1, wherein said non-metal shield is secured to but not permanently joined to said vacuum envelope of said vacuum interrupter.

3. The non-metal shield of claim 1, wherein said non-metal shield comprises an electrical insulator material, a semiconductor material, a non-metal inorganic conductor material, or combinations thereof, wherein said non-metal shield is predominantly non-metallic.

4. The non-metal shield of claim 3 comprising a non-metal material selected from the group consisting of boron nitride, cordierite, zirconia, silicon carbide, silicon nitride, silica, magnesium aluminate, alumina, mullite, zinc oxide, titanium oxide, porous silicon, graphite, and graphene.

5. The non-metal shield of claim 1 comprising a high surface area material with a porosity of at least 50%.

6. The non-metal shield of claim 1 further comprising at least one protrusion protruding radially inward toward said contact gap of said vacuum interrupter.

7. A non-metal shield of a vacuum interrupter, said vacuum interrupter comprising a vacuum envelope and said non-metal shield inside said vacuum envelope,
wherein said non-metal shield is not a member of said vacuum envelope,
wherein said non-metal shield is not a thin layer on a metal substrate, and
wherein said non-metal shield is secured in a fixed position by at least one member of said vacuum envelope, but is not permanently joined to any member of said vacuum envelope if said non-metal shield is a ceramic or a glass, or is joined permanently to said vacuum envelope via a metal insert into said non-metal shield if said non-metal shield is a glass.

8. The non-metal shield of claim 7, wherein said non-metal shield comprises an electrical insulator material, a semiconductor material, a non-metal inorganic conductor material, or combinations thereof, wherein said non-metal shield is predominantly non-metallic.

9. The non-metal shield of claim 7, wherein a metal shield for triple junction protection, as defined in the specification, in close proximity to a metal-insulator-vacuum triple junction or a metal-insulator-gas triple junction, is encapsulated completely or partially inside said non-metal shield.

10. The non-metal shield of claim 9, wherein said metal-insulator-gas triple junction is sealed with an insulating sealant such as a conformal coating, and/or covered with an insulating protection means such as heat-shrink sleeve or electrical tape, on the exterior of said vacuum envelope.

11. The non-metal shield of claim 7, wherein said non-metal shield is a triple junction plug, as defined in the specification, for a metal-insulator-vacuum triple junction or a metal-insulator-gas triple junction, by blocking the line-of-sight from said triple junction to other metal components away from said triple junction and inside said vacuum envelope of said vacuum interrupter.

12. The non-metal shield of claim 11, wherein said metal-insulator-gas triple junction is sealed with an insulating sealant such as a conformal coating, and/or covered with an insulating protection means such as heat-shrink sleeve or electrical tape, on the exterior of said vacuum envelope.

13. The non-metal shield of claim 7 comprising a high surface area material with a porosity of at least 50%.

14. The non-metal shield of claim 13 comprising a foam of a material selected from the group consisting of cordierite, calcium aluminate, silicon nitride, alumina, mullite, boron nitride, zirconia, silicon carbide, silica, and carbon.

15. A high surface area shield of a vacuum interrupter, said vacuum interrupter comprising a vacuum envelope, a pair of separable contacts and said high surface area shield inside said vacuum envelope,
wherein the porosity of said high surface area shield is at least 50%, and
wherein said high surface area shield is not a getter as commonly used in a vacuum interrupter (for absorption and adsorption of active gases).

16. The high surface area shield of claim 15 comprising a foam of a metal or a foam of an inorganic material.

17. A vacuum interrupter comprising a vacuum envelope and a non-metal shield as set forth in claim 1 inside said vacuum envelope.

18. A vacuum interrupter comprising a vacuum envelope and a non-metal shield as set forth in claim 7 inside said vacuum envelope.

19. A vacuum switching apparatus comprising a vacuum interrupter as set forth in claim 17 and a driving mechanism operatively connected with said vacuum interrupter.

20. A vacuum switching apparatus comprising a vacuum interrupter as set forth in claim 18 and a driving mechanism operatively connected with said vacuum interrupter.
